(19) United States
(12) Patent Application Publication
(10) Pub. No.: US 2026/0146660 A1
(43) Pub. Date: May 28, 2026

(54) TRIANGULAR PRISMATIC TUNED MASS DAMPER SUITABLE FOR LARGE-SPAN OR CANTILEVER STRUCTURES

(71) Applicant: TONGJI UNIVERSITY, Shanghai (CN)

(72) Inventors: Zheng LU, Shanghai (CN); Yelei SHEN, Shanghai (CN); Ruoyu ZHAO, Shanghai (CN)

(73) Assignee: TONGJI UNIVERSITY, Shanghai (CN)

(21) Appl. No.: 18/860,004

(22) PCT Filed: Feb. 27, 2024
(86) PCT No.: PCT/CN2024/078757

§ 371 Date: Oct. 25, 2024

(30) Foreign Application Priority Data
Sep. 26, 2023 (CN) 202311245112.9

(51) Int. Cl. F16F 7/104; E04B 1/98; E04H 9/02

(52) U.S. Cl. CPC F16F 7/104; E04B 1/98; E04H 9/028

(57) ABSTRACT

The invention involves a triangular prismatic tuned mass damper suitable for large-span or cantilever structures, including a triangular prism box, particle damping units inside the triangular prism box, and a steel mass block. Below the triangular prism box are high-damping springs. The particle damping unit consists of a particle damping cavity, particles of three different sizes, and foam rubber pads. When the structural vibration amplitude is small, the particles dissipate energy by compressing the foam rubber pads and rolling. When the amplitude of structural vibration is large, the energy is dissipated by the collision of particles and the compression of the foam rubber.

### TECHNICAL FIELD

The present invention belongs to the field of vibration control technology in civil engineering structures and specifically relates to a triangular prismatic tuned mass damper suitable for large-span or cantilever structures.

### DESCRIPTION OF RELATED ART

With the development of civil engineering technology, the scale and capacity of buildings are continually increasing, and structural forms are becoming more innovative. To meet functional and aesthetic demands, records for large spans and long cantilevers are frequently updated. However, in addition to vibrations caused by earthquakes, large-span and cantilever structures are prone to vertical resonance with their low natural frequencies that are close to human activity frequencies. This resonance can increase structural forces and compromise the reliability of the structures. For large, densely populated structures such as theaters, airports, and shopping malls, walking-induced vertical vibrations can result in significant load effects. Additionally, human-induced structural vibrations not only affect structural safety and reliability but also impact human comfort. Therefore, enhancing the vertical vibration mitigation capability of large-span or cantilever structures is of significant importance.

Generally, increasing the structural stiffness is a common method to reduce the vibration response of large-span or cantilever structures. However, this approach not only increases material usage and construction costs but also adds to the structure's inertia, leading to greater internal forces under dynamic loads. Additionally, it may negatively impact the aesthetic requirements of the building. Therefore, to achieve better economic efficiency and structural reliability, supplementary damping devices can be employed for large-span or cantilever structures. Among various damping devices, tuned mass dampers offer particularly significant vibration mitigation effects.

A Tuned Mass Damper (TMD) consists of a mass, a spring, and a damping system. Its natural frequency is designed to be near the fundamental frequency of the primary structure so that resonance characteristics are altered and vibration reduction is achieved. They have been used in large-span structures like the Jan Linzelviaduct in the Netherlands, the Millennium Bridge in London, and Delhi Airport in India. However, TMDs have notable drawbacks, including their narrow effective frequency bandwidth and significant working stroke. If the natural frequency of the structure changes, the damper may become malfunctioning. To address these shortcomings, multiple TMDs could be used to cover various frequency bands, but this increases costs and poses economic challenges.

### SUMMARY

The purpose of this invention is to address issues such as the narrow frequency bandwidth, large working stroke in traditional tuned mass dampers, and noise generated by particle collisions by providing a triangular prismatic tuned mass damper suitable for large-span or cantilever structures.

The objective of the invention can be achieved through the following technical solution: A triangular prismatic tuned mass damper suitable for large-span or cantilever structures includes a triangular prism box, high-damping springs mounted below the box, and a steel mass block along with multiple particle damping units inside the box.

Furthermore, the high-damping spring is connected at its upper end to the triangular prism box and at its lower end to the large-span cantilever structure for vertical vibration control.

Furthermore, the edges of the steel mass block are tangential to the triangular prism box, and the particle damping units are positioned in the space between the box and the steel mass block.

Furthermore, the particle damping units include particle damping cavity and foam rubber pads on the cavity's inner surface. The large, medium, and small particles are placed on the foam pad inside the cavity.

Furthermore, the steel diaphragm inside the box divides the space above the steel mass block into two particle damping units.

Furthermore, two particle damping units are formed on the top and each side of the steel mass block.

Furthermore, the shape of the particle damping units is a prism with a cross-section of a right-angle triangle so that the energy dissipation from particle collisions is enhanced.

Furthermore, the particle damping units are symmetrically arranged to balance horizontal collision forces within the damper.

Furthermore, the large, medium, and small particles are placed in the cavity in such an order that the diameter of the particles aligns with the height of the cavity.

Furthermore, the spacing between the large particles is less than the diameter of the medium ones, and the spacing between the medium particles is less than the diameter of the small ones.

Furthermore, the diameter of the large particles is between 0.56 and 0.64 times the maximum height of the particle damping cavity, with a preferred ratio of 0.6.

Furthermore, the diameter of the medium particles is between 0.30 and 0.35 times the maximum height of the particle damping cavity, with a preferred ratio of 0.33.

Furthermore, the diameter of the small particles is between 0.15 and 0.19 times the maximum height of the particle damping cavity, with a preferred ratio of 0.17.

Furthermore, the large particles include a large particle foam rubber outer layer and a large steel core inside; the medium particles include a medium particle foam rubber outer layer and a medium steel core inside; the small particles include a small particle foam rubber outer layer and a small steel core inside.

Furthermore, there are multiple arcuate concavities on the surface of the foam rubber pads at the bottom of the particle damping cavity. The large, medium, and small particles are placed at the bottoms of these arcuate concavities.

Furthermore, the radius of curvature of these arcuate concavities is 2.8-3.2 times the radius of the respective particles, preferably 3 times.

Furthermore, when the amplitude of structural vibration is small, the particles dissipate energy through rolling and compression of the foam rubber pads. If the amplitude becomes larger, energy is dissipated through collisions and compression of the foam rubber.

Furthermore, the natural frequency of the damper is adjusted to be close to the fundamental frequency of the large-span or cantilever structure by modifying the mass of the steel mass block and the stiffness of the high-damping springs.

Furthermore, the total mass of the triangular prism box is 0.5%-2% of the mass of the large-span or cantilever structure, preferably 1%.

The invention also provides the application of the triangular prismatic tuned mass damper suitable for large-span or cantilever structures in the field of vibration control for large-span or cantilever structures.

Compared to existing technology, this invention has the following beneficial effects:
(1) This invention applies particle damping technology to control vertical vibrations in structures. Incorporating particle damping units reduces the dynamic response of large-span or cantilever structures under seismic or human-induced vibrations and expands the energy dissipation mechanism of particle damping under vertical excitations. Under different amplitude of vibrations, the invention utilizes particles and foam rubber pads to dissipate energy in various ways, creating a phased energy dissipation mechanism with a relatively simple configuration. What's more, this invention is able to control structural vibration caused by both human-induced and seismic action with one type of damper. When the amplitude of structural vibration is small, the particles dissipate energy through rolling and the compression of the foam rubber pads. When the amplitude is large, energy is dissipated through collisions and compression of the foam rubber. This phased energy dissipation mechanism also resolves issues associated with traditional tuned mass dampers, such as narrow vibration reduction bandwidth, large working stroke, and noise from particle collisions.
(2) In this invention, the particle damping units with triangular cross-section increase the probability of collisions between particles and collisions between particles and the cavity walls under vertical vibrations compared to rectangular units. Because the size variation of the particles aligns with the height variation of the damping cavity. Since the size of the particles and the height of the cavity are in a specific ratio, the relative positions of particles of different sizes remain stable, and stacking of particles is less likely to occur. The movement and collision trajectories of the particles are confined to a smaller area, which reduces the randomness of their movement. Additionally, the diagonal top surface of the damping cavity ensures that smaller particles move towards and collide with larger particles during vibrations, maintaining the energy dissipation mechanism throughout the vibration process. The diagonal top also provides drainage, which helps prevent the accumulation of water, snow, or dust, thereby reducing the instability of mass and the likelihood of detuning.
(3) This invention utilizes foam rubber pads as both a nonlinear energy-dissipating material and a noise-reducing agent. On one hand, the foam rubber pads enhance energy dissipation; on the other hand, they reduce the noise generated from collisions between particles and the cavity's inner surface, making them especially suitable for acoustically sensitive buildings like theatres. By dispersing foam rubber pads among the particles and on the inner walls of the damping cavity, the thickness of the foam rubber pads can be minimized while maintaining energy-dissipating deformation reserves, and reducing noise from particle collisions. Additionally, the rough surface of the foam rubber pads provides a higher coefficient of friction. As particles roll and collide within the cavity, the relative movement between foam rubber surfaces enhances frictional energy dissipation. Under human-induced vibrations with small amplitude, the arc-shaped concavities on the foam rubber pads promote horizontal rolling of the particles, increasing energy dissipation through rolling friction, and helping the particles return to their initial positions after vibrations. During larger amplitude seismic events, when particles collide with the cavity bottom at an angle, the arcuate concavities on the foam rubber pads increase the margin of deformation of the energy-dissipating material during compression, thereby improving energy dissipation efficiency.

### BRIEF DESCRIPTION OF THE DRAWINGS

FIG. 1 is a front view of the triangular prismatic tuned mass damper according to the present invention.

FIG. 2 is a three-dimensional view of the triangular prism box of the present invention.

FIG. 3 is a cross-sectional view of the triangular prismatic tuned mass damper according to the present invention.

FIG. 4 is a top-down schematic view of the particle arrangement according to the present invention.

FIG. 5 is a cross-sectional view of the particles according to the present invention.

FIG. 6 is a side-view schematic of the particle arrangement according to the present invention.

FIG. 7 is a schematic diagram of the collision mechanism of the particle damping unit according to the present invention.

### REFERENCE SIGNS

1—the triangular prism box, 2—the high-damping springs, 3—the steel mass block, 4—the particle damping unit, 5—the particle damping cavity, 6—the large particles, 6.1—the large particle foam rubber outer layer, 6.2—the large steel core, 7—the medium particles, 7.1—the medium particle foam rubber outer layer, 7.2—the medium steel core, 8—the small particles, 8.1—the small particle foam rubber outer layer, 8.2—the small steel core, 9—the foam rubber pads, 9.1—the arcuate concavities, 10—the steel diaphragm.

### DESCRIPTION OF THE EMBODIMENTS

Below, the invention will be described in detail with reference to the accompanying figures and specific embodiments. These embodiments are based on the technical solution of the invention and provide detailed methods and specific procedures. However, the scope of protection for the invention is not limited to the following embodiments.

### Embodiment 1

This embodiment provides a triangular prismatic tuned mass damper suitable for large-span or cantilever structures which is installed on large-span or cantilever structures that require vertical vibration control. The triangular prismatic tuned mass damper in this embodiment includes a triangular prism box 1, high-damping springs 2 which are installed below the triangular prism box 1, and a steel mass block 3 and multiple particle damping units 4 inside the triangular prism box 1. The top of the high-damping springs 2 is connected to the triangular prism box 1, and the bottom is connected to the large-span or cantilever structure requiring vertical vibration control. The edges of the steel mass block 3 are in contact with the triangular prism box 1, and the particle damping units 4 are arranged in the remaining space inside the triangular prism box 1. The particle damping units 4 include a particle damping cavity 5, foam rubber pads 9 which are mounted on the inner surface of the particle damping cavity 5, and large particles 6, medium particles 7, and small particles 8 which are placed on the foam rubber pads 9. When the structure's vibration amplitude is small, the particles of different sizes roll and dissipate energy by compressing the foam rubber pads 9. When the vibration amplitude is large, the particles dissipate energy through collisions that compress the foam rubber pads 9.

### Embodiment 2

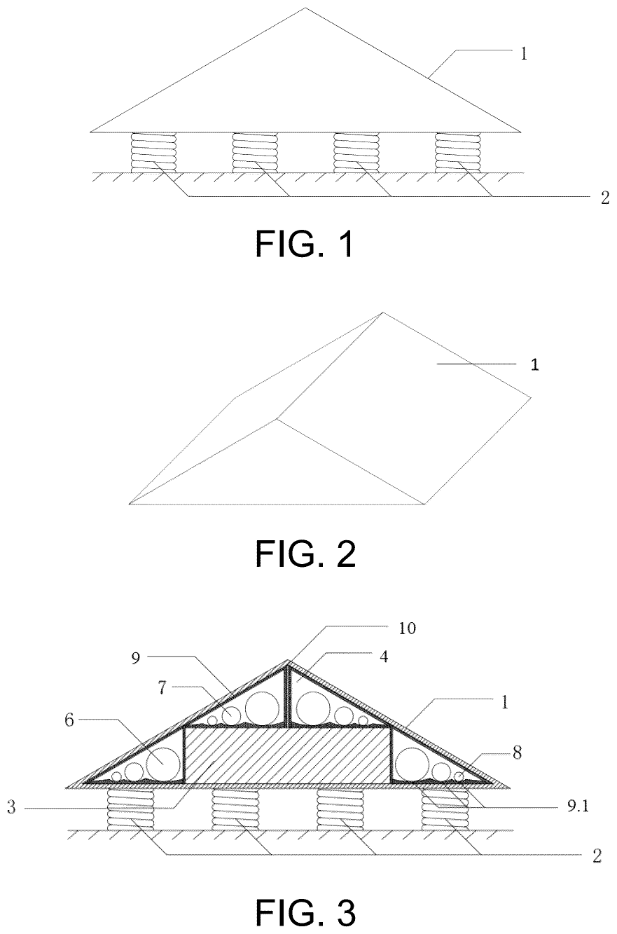

This embodiment provides a triangular prismatic tuned mass damper suitable for large-span or cantilever structures, which is installed at the mid-span of the large-span structure requiring vertical vibration control. As shown in FIG. 1, the triangular prismatic tuned mass damper in this embodiment includes a triangular prism box 1, high-damping springs 2 which are installed below the triangular prism box 1, and a steel mass block 3 along with multiple particle damping units 4 placed inside the triangular prism box 1.

The top of the high-damping springs 2 is connected to the triangular prism box 1, while the bottom is connected to the large-span structure requiring vertical vibration control. By adjusting the mass of the steel mass block 3 and the stiffness of the high-damping springs 2, the natural frequency of the damper is made to closely match the vertical vibration frequency of the large-span structure, achieving the tuning effect. The mass of the steel mass block 3 ensures that the total mass of the triangular prism box 1 is 1% of the mass of the large-span structure.

As shown in FIG. 3, the steel mass block 3 in this embodiment is a right rectangular prism. The front and rear ends of the steel mass block 3 are in contact with the front and rear ends of the triangular prism box 1, respectively. The edges of the steel mass block 3 are tangential to the triangular prism box 1, and the particle damping units 4 are arranged in the remaining space within the triangular prism box 1. A steel diaphragm 10 is placed between the triangular prism box 1 and the steel mass block 3. Two particle damping units 4 are formed at the upper end and both sides of the steel mass block 3. In this embodiment, the particle damping units 4 are prismatic with a cross-section in the shape of a right triangle. The particle damping units 4 are symmetrically arranged so that horizontal impact forces can achieve self-balancing within the damper.

As shown in FIGS. 3, 4, and 6, the particle damping unit 4 includes a particle damping cavity 5, foam rubber pads 9 mounted on the inner surface of the particle damping cavity 5, large particles 6, medium particles 7, and small particles 8 placed on the foam rubber pads 9. Within the particle damping cavity 5, the large particles 6, medium particles 7, and small particles 8 are arranged in decreasing diameter order as the height of the cavity decreases. The distance between the large particles 6 is less than the diameter of the medium particles 7, and the distance between the medium particles 7 is less than the diameter of the small particles 8. The diameter of the large particles 6 is 0.6 times the maximum height of the particle damping cavity 5; the diameter of the medium particles 7 is 0.33 times the maximum height of the particle damping cavity 5; and the diameter of the small particles 8 is 0.17 times the maximum height of the particle damping cavity 5.

As shown in FIG. 5, the large particles 6 consist of a large particle foam rubber outer layer 6.1 and a large steel core 6.2 encapsulated inside. The medium particles 7 have a medium particle foam rubber outer layer 7.1 and a medium steel core 7.2 inside. The small particles 8 are composed of a small particle foam rubber outer layer 8.1 and a small steel core 8.2.

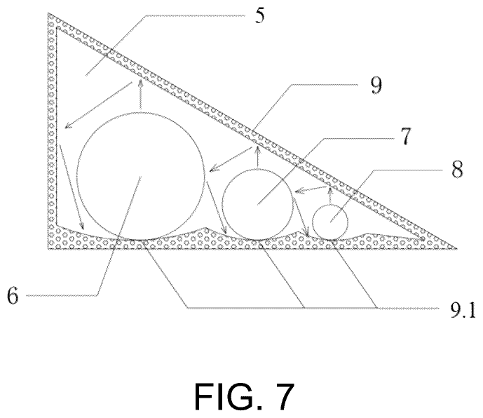

As shown in FIG. 7, there are multiple arcuate concavities 9.1 on the surface of the foam rubber pads 9 at the bottom of the particle damping cavity 5. The large particles 6, medium particles 7, and small particles 8 are each tangent to the arc bottoms of these arcuate concavities 9.1. In this embodiment, the radius of curvature of the arcuate concavities 9.1 is three times the radius of the large particles 6, medium particles 7, and small particles 8, respectively.

### Embodiment 3

This embodiment provides a triangular prismatic tuned mass damper suitable for large-span or cantilever structures, which is placed at the cantilever end of the structure requiring vibration control. It includes a triangular prism box 1 with an isosceles triangular cross-section, as shown in FIG. 2. FIG. 3 illustrates that the triangular prism box 1 is composed of a steel mass block 3 and four particle damping units 4. Below the triangular prism box 1 are high-damping springs 2, with its lower end connected to the large-span or cantilever structure for vertical vibration control.

In this embodiment, a steel diaphragm 10 is fixed between the triangular prism box 1 and the steel mass block 3, creating two particle damping units 4 above the steel mass block 3. Surrounding the steel mass block 3 are four particle damping units 4, each of which has a prismatic shape with a right-angled triangular cross-section.

In this embodiment, each particle damping unit 4 includes a damping cavity 5, large particles 6, medium particles 7, small particles 8, and foam rubber pads 9. The foam rubber pads 9 are fixed to the inner surface of the particle damping unit 4, while the large, medium, and small particles are placed inside the damping cavity 5.

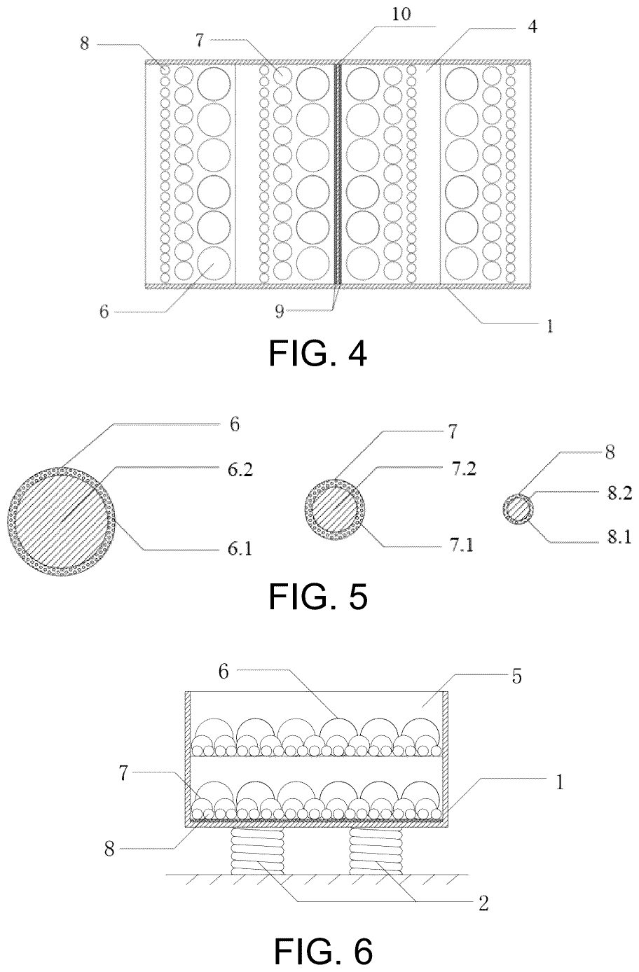

In this embodiment, as shown in FIG. 3, inside the particle damping unit 4, the large particles 6, medium particles 7, and small particles 8 are sequentially placed in the damping cavity 5 from the highest to the lowest height. As depicted in FIG. 4, the distance between the large particles 6 is smaller than the diameter of the medium particles 7, and the distance between the medium particles 7 is smaller than the diameter of the small particles 8.

In this embodiment, as shown in FIG. 5, the large particles 6 consist of a large steel core 6.2 and a large particle foam rubber outer layer 6.1, with the outer layer 6.1 covering the steel core 6.2. The medium particles 7 have a medium steel core 7.2 and a medium particle foam rubber outer layer 7.1, with the outer layer 7.1 wrapping the steel core 7.2. The small particles 8 are composed of a small steel core 8.2 and a small particle foam rubber outer layer 8.1, where the outer layer 8.1 encases the steel core 8.2.

Specifically, by adjusting the mass of the steel mass block 3 and the stiffness of the high-damping springs 2, the natural frequency of the damper is tuned to be close to the natural frequency of the cantilever structure's vertical vibration. In this embodiment, the mass of the steel mass block 3 ensures that the total mass of the triangular prism box 1 is 1% of the mass of the cantilever structure.

Specifically, all the particle damping units 4 are symmetrically arranged so that the horizontal collision forces generated when the large particles 6, medium particles 7, and small particles 8 collide can self-balance within the damper. The edges of the steel mass block 3 align with the triangular prism box 1, allowing the triangular prism box 1 to precisely accommodate the steel mass block 3.

Specifically, as shown in FIG. 6, the diameter of the large particles 6 is 0.6 times the maximum height of the particle damping cavity 5; the diameter of the medium particles 7 is ⅓ of the maximum height; and the diameter of the small particles 8 is ⅙ of the maximum height. Additionally, the foam rubber pads 9 at the bottom of the particle damping unit 4 features arcuate concavities 9.1. The radius of these concavities is three times the radius of the large, medium, and small particles, with these balls placed at the bottom of the concave surface 9.1.

The working principle of the present invention is as follows.

After tuning, when the cantilever structure experiences minor vibrations under human-induced excitation, the resonance amplitude of the box is small. Due to inertia, the resonance of the triangular prism box 1 causes relative motion between the particle damping cavity 5 and the particles, causing the steel core of the particles to compress the foam rubber pads 9 and the foam rubber outer layer of the particles, which deform to dissipate the vibration energy. Human-induced vibrations, such as walking and leaning on the railing, apply horizontal excitation to the structure. The inclination of the damper box during resonance and the uneven contact between the particles and the cavity surface, along with the horizontal component of the restoring force generated when the foam rubber pads 9 with the arcuate concavities 9.1 are compressed cause the particles to roll even with small amplitudes. As particles compress the foam rubber pads and roll back and forth within the arcuate concavities 9.1, the kinetic energy is transformed into the gravitational potential energy while energy dissipation is also achieved by friction. The more particles deviate from their initial positions, the more energy is dissipated through friction, and the greater the restoring force generated by the foam rubber pads 9. After the vibration ends, the particles return to their initial positions.

When the cantilever structure experiences vibrations of large amplitude due to seismic action, the resonance amplitude of the box is also significant. At this point, the particles will bounce within the particle damping cavity 5 and experience inelastic collisions with the inner walls of the particle damping cavity 5, compressing the foam rubber pads and thereby dissipating energy.

The energy dissipation mechanism of particle collisions is illustrated in FIG. 7. When particles are bouncing, vertical excitation can also cause particles to move horizontally upon contact with the cavity's diagonal surfaces. This results in collisions between the small particles 8 and the medium particles 7, the medium particles 7 and the large particles 6, and the large particles 6 and the cavity's sidewalls. Subsequently, the particles collide with the bottom of the cavity.

In this embodiment by specifying the sizes of the particles according to the height of the particle damping cavity, particle stacking can be prevented. The movement and collision trajectories of the particles are confined to a smaller space. This ensures that the relative positions of the three types of particles remain unchanged, thereby reducing the randomness of particle motion. As long as the relative positions of the three particle sizes remain constant, the collision energy dissipation mechanism shown in FIG. 7 can be repeatedly achieved.

Under vertical vibration, the particles also exhibit horizontal movement simultaneously, increasing the number of collisions and enhancing energy dissipation efficiency. During collisions, the foam rubber pads 9 and the foam rubber outer layers of the particles are compressed, leading to nonlinear energy dissipation. When particles collide with the bottom of the cavity, the collisions are inclined. The foam rubber pads 9 with an arc-shaped concavities surface 9.1 provide more margin for deformation, allowing for more energy to be dissipated. During vibration, particles may roll on the surface of the arcuate concavities. Since the relative movements between particles or between particles and the cavity may occur, friction also contributes to energy dissipation.

The description of the embodiments above is intended to facilitate understanding and application of the invention by those skilled in the art. Those familiar with the technology can readily modify these embodiments and apply the general principles disclosed to other embodiments without requiring inventive effort. Therefore, the invention is not limited to the described embodiments, and any improvements and modifications made by those skilled in the art that do not depart from the scope of the invention should fall within the protection of the invention.

1. A triangular prismatic tuned mass damper suitable for large-span or cantilever structures, the triangular prismatic tuned mass damper comprising a triangular prism box, high-damping springs installed below the triangular prism box, a steel mass block and multiple particle damping units arranged inside the triangular prism box for vibration mitigation,
an upper end of the high-damping spring is connected to the triangular prism box, and a lower end of the high-damping spring is connected to the large-span or cantilever structure that requires vertical vibration control,
edges of the steel mass block are tangential to the triangular prism box, and the particle damping units are set in a space between the triangular prism box and the steel mass block,
the particle damping units include a particle damping cavity, a foam rubber pad mounted on an inner surface of the particle damping cavity, large particles, medium particles, and small particles which are placed on the foam rubber pad,
wherein the large particles include a large particle foam rubber outer layer and a large steel core inside, the medium particles include a medium particle foam rubber outer layer and a medium steel core inside, and the small particles include a small particle foam rubber outer layer and a small steel core inside.

2. The triangular prismatic tuned mass damper suitable for large-span or cantilever structures according to claim 1, wherein a steel diaphragm is placed between the triangular prism box and the steel mass block to separate a space above the steel mass block into two particle damping units.

3. The triangular prismatic tuned mass damper suitable for large-span or cantilever structures according to claim 1, wherein two particle damping units are formed either above or beside the steel mass block; a shape of the particle damping units is a prism that has a right-angled triangular cross-section, and the particle damping units are symmetrically arranged.

4. The triangular prismatic tuned mass damper suitable for large-span or cantilever structures according to claim 1, wherein within the particle damping cavity, the large particles, the medium particles, and the small particles with decreasing diameters are placed sequentially along a direction of decreasing height of the particle damping cavity.

5. The triangular prismatic tuned mass damper suitable for large-span or cantilever structures according to claim 4, wherein a distance between the large particles is smaller than a diameter of the medium particles, and a distance between the medium particles is smaller than a diameter of the small particles.

6. The triangular prismatic tuned mass damper suitable for large-span or cantilever structures according to claim 4, wherein a diameter of the large particles to a maximum height of the particle damping cavity is in the range of, a diameter of the medium particles to a maximum height of the particle damping cavity is in the range of 0.30.35, and a diameter of the small particles to a maximum height of the particle damping cavity is in the range of 0.15-0.18.

7. (canceled)

8. The triangular prismatic tuned mass damper suitable for large-span or cantilever structures according to claim 1, wherein a surface of the foam rubber pad at a bottom of the particle damping cavity includes multiple arcuate concavities, with the large particles, medium particles, and small particles respectively placed at a bottom of the arcuate concavities.

9. The triangular prismatic tuned mass damper suitable for large-span or cantilever structures according to claim 8, wherein a radius of curvature of the arcuate concavities is 2.8 to 3.2 times a radius of the large particles, medium particles, and small particles, respectively.

10. An application of a triangular prismatic tuned mass damper suitable for large-span or cantilever structures according to claim 1 in the field of vibration control for large-span or cantilever structures.
